(19) United States
(12) Patent Application Publication
(10) Pub. No.: US 2018/0001395 A1
(43) Pub. Date: Jan. 4, 2018

(54) DUST VACUUMING DRILL DEVICE WITH AN INTERNAL DUST PASSAGEWAY AND METHOD FOR PRODUCING THE SAME

(71) Applicant: SHEHKAI PRECISION CO., LTD., Kaohsiung City (TW)

(72) Inventor: Tai-Yuan TU, Kaohsiung City (TW)

(21) Appl. No.: 15/197,943

(22) Filed: Jun. 30, 2016

(51) Int. Cl. B23B 51/04; A47L 7/00; B23P 15/28; B28D 1/14; B28D 7/02

(52) U.S. Cl. CPC B23B 51/04; B28D 1/146; B28D 7/02; B23P 15/28; A47L 7/0095; B23B 2226/75; B23B 2251/68; B23B 2270/30

(57) ABSTRACT

A dust vacuuming drill device is adapted to be connected with a vacuum suction device by a socket, and includes a drill bit and a driven shank threadedly engaged with each other and cooperatively defining therein an internal dust passageway in communication with the socket for removing the dust generated during a drilling operation. The drill unit can be removed from the driven shank when the drill unit is broken so as to readily replace the drill unit without the need to detach the driven shank from the socket, which results in low operation and material costs.

### FIELD

The disclosure relates to a dust vacuuming drill device, and more particularly to a dust vacuuming drill device with an internal dust passageway, and method for producing the drill device.

### BACKGROUND

Referring to FIG. 1, a conventional drill bit 1 includes a chucking portion 11, a dust removing portion 12 and a bit tip 13. A spirally extending groove 121 is formed in the dust removing portion 12 such that most of dust generated in drilling a hole 101 into a concrete surface 100 is removed along the groove 121. However, some dust and swarf may remain in the drilled hole 101 so that a further dust removal work is required.

Therefore, referring to FIG. 2, a conventional dust vacuuming drill device 2 was developed, and includes a hollow drill bit unit 21 and an adaptor unit 22. The drill bit unit 21 includes a tubular bit shaft 212 having an end to be coupled with a driving device (not shown) for rotating the drill bit unit 21, and a bit tip 211 connected to an opposite end of the bit shaft 212. The bit shaft 212 and the bit tip 211 respectively have through holes 202, 201. The adaptor unit 22 includes a housing 221 which is sleeved on the bit shaft 212 by a bearing 222 and which defines a chamber 220 in communication with the through hole 202. The adaptor unit 22 has a connecting end 223 to be connected to a vacuum suction device 23.

Accordingly, drilling dust can be sucked from the through hole 201 into the suction device 23 through the tubular bit shaft 212, the through hole 202 and the chamber 220. However, with such a tubular shaft structure of the hollow drill bit unit 21, the bit tip 211 directly contacting a concrete surface 100 is liable to break and damage, which renders the entire drill device 2 nonfunctional. Increasing the diameter of the bit tip or reducing the dimension of the through hole 201 to solve the above-described problem results in complicated production process and low vacuum effect.

### SUMMARY

Therefore, an object of the disclosure is to provide a dust vacuuming drill device that can alleviate at least one of the drawbacks of the prior art.

According to the disclosure, the dust vacuuming drill device includes a drill unit and a driven shank. The drill unit includes a bit shaft having a tubular shaft wall which is elongated in a lengthwise direction to terminate at proximate and distal shaft ends and which has a shaft inner wall surface that defines a longitudinal passage extending in the lengthwise direction and through the proximate shaft end, a bit tip integrally connected to the distal shaft end and having at least one first penetrating hole in communication with the longitudinal passage for dust access to the longitudinal passage, and an externally threaded portion disposed on the proximate shaft end. The driven shank includes a shank body having a tubular shank wall which is elongated in the lengthwise direction to terminate at proximate and distal shank ends such that the tubular shank wall is disposed to penetrate through a communicating chamber of a socket from one bit end of the socket to project the proximate shank end outwardly from the other bit end of the socket, and which has a shank inner wall surface that defines a communicating passage extending in the lengthwise direction and through the proximate shank end, and at least one second penetrating hole which is configured in communication with the communicating passage and which is adapted to be disposed in the communicating chamber to be in communication with a suction device end of the socket, a driven portion integrally connected to the distal shank end for coupling with a driving device, and an internally threaded portion disposed on the proximate shank end and configured to be threadedly engaged with the externally threaded portion to communicate the longitudinal passage with the communicating passage such that the first penetrating hole, the longitudinal passage, the communicating passage and the second penetrating hole cooperatively define an internal dust passageway.

A method for producing a drill unit of a dust vacuuming drill device, comprising: providing a tubular shaft which has a longitudinal passage therein opened at a proximate shaft end, forming external threads on the proximate shaft end of the tubular shaft, forming at least one slot in a distal shaft end of the tubular shaft opposite to the proximate shaft end, welding a bit tip to the slot, and drilling into the bit tip at least one penetrating hole in communication with the longitudinal passage.

A method for producing a driven shank of a dust vacuuming drill device, comprising: providing a tubular shank which has a communication passage therein opened at a proximate shank end, forming an internally threaded portion on the proximate shank end, pressing an opposite end of the tubular shank to form a plurality of retaining grooves therein, and drilling into the tubular shank between the internally threaded portion and the retaining grooves at least one penetrating hole in communication with the communication passage.

### BRIEF DESCRIPTION OF THE DRAWINGS

Other features and advantages of the disclosure will become apparent in the following detailed description of the embodiment with reference to the accompanying drawings, of which:

FIG. 1 is a schematic view illustrating a conventional drill bit drilling into a concrete surface;

FIG. 2 is a schematic exploded side view illustrating a conventional dust vacuuming drill device;

FIG. 3 is an exploded perspective view of an embodiment of a dust vacuuming drill device according to the disclosure;

FIG. 4 is a side view illustrating the embodiment connected with a vacuum suction device by a socket;

FIG. 5 is a fragmentary perspective view of a bit tip of a drill unit according to the embodiment;

FIG. 6 is a fragmentary perspective view of the bit tip in a modified form;

FIGS. 7 to 10 are schematic top views of the tool bit in different forms;

FIGS. 11 to 15 are schematic side views illustrating the method for producing the drill unit according to the embodiment; and

FIGS. 16 to 19 are schematic side views illustrating the method for producing a driven shank of the dust vacuuming drill device according to the embodiment.

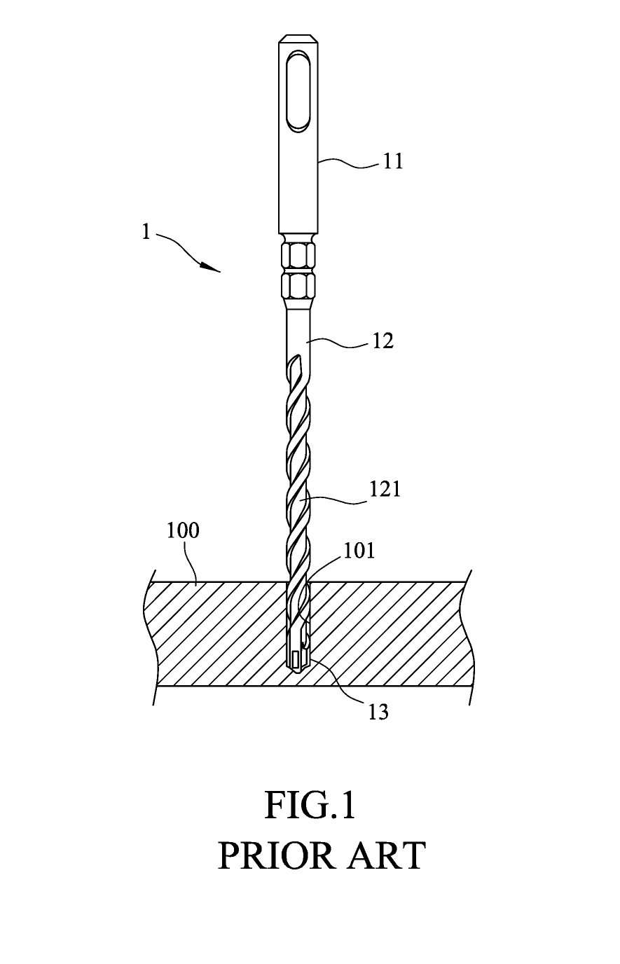

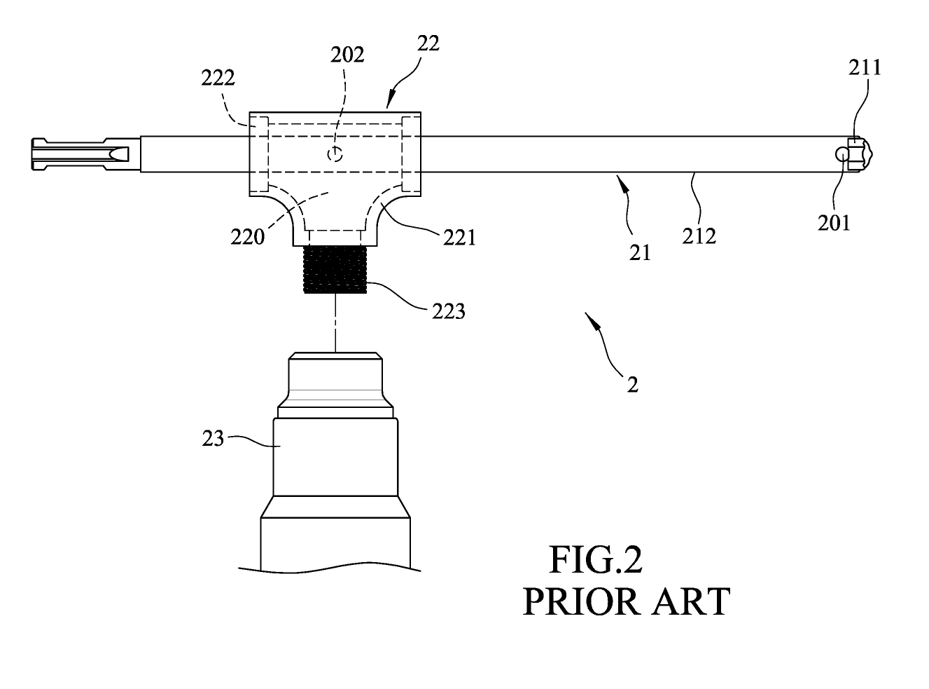

### DETAILED DESCRIPTION

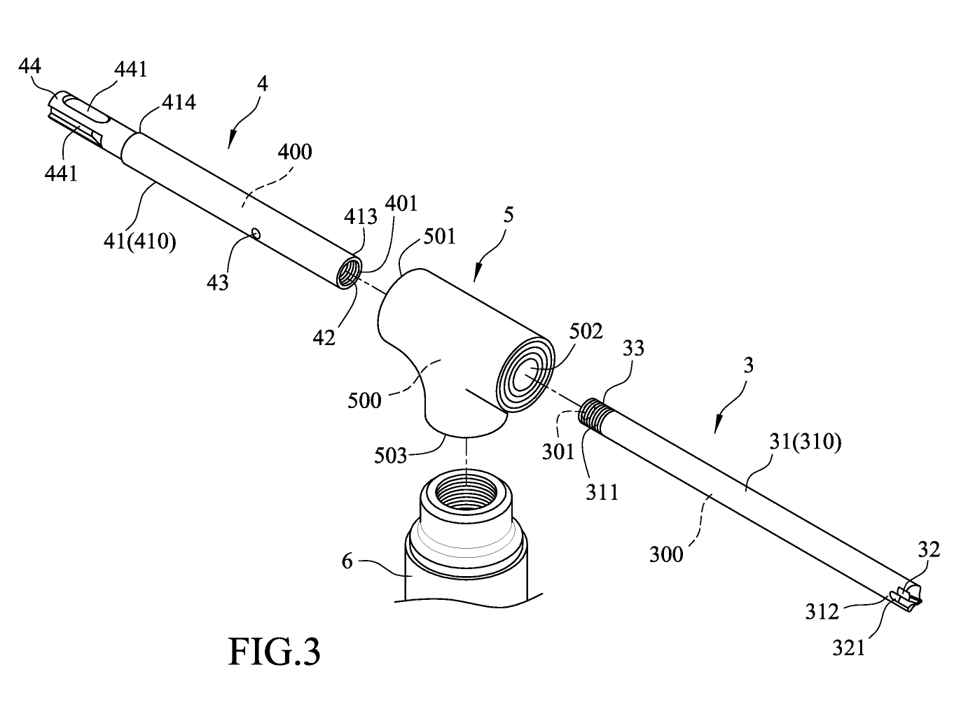

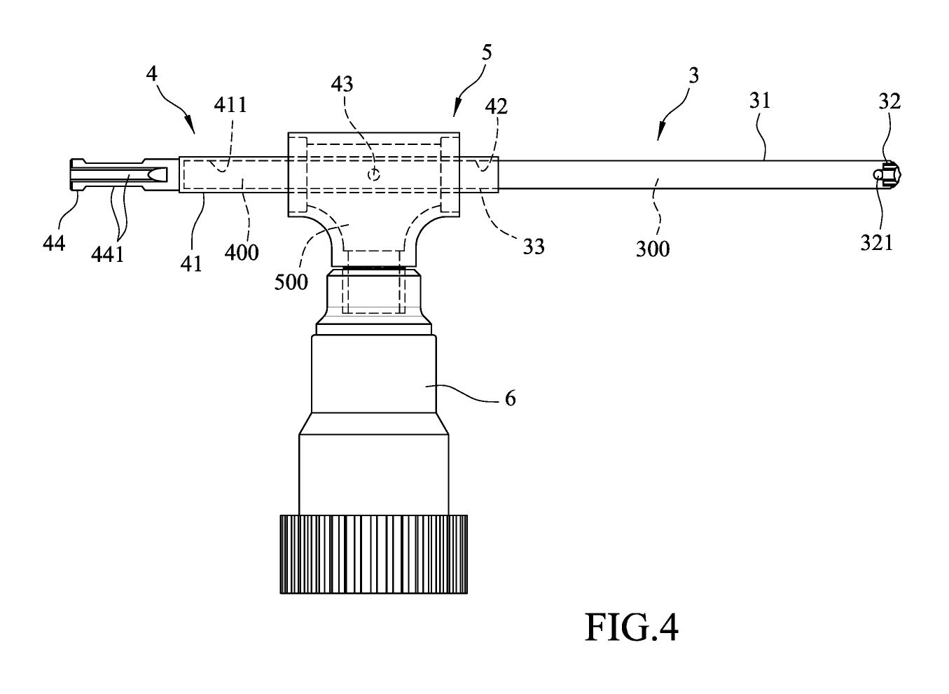

Referring to FIGS. 3 and 4, the embodiment of the dust vacuuming drill device is adapted to be connected with a vacuum suction device 6 by a socket 5. The socket 5 defines a communicating chamber 500 that has two bit ends 501, 502 opposite to each other in a lengthwise direction, and a suction device end 503 disposed transverse to the lengthwise direction to be engaged with the vacuum suction device 6. The dust vacuuming drill device of the embodiment includes a drill unit 3 and a driven shank 4.

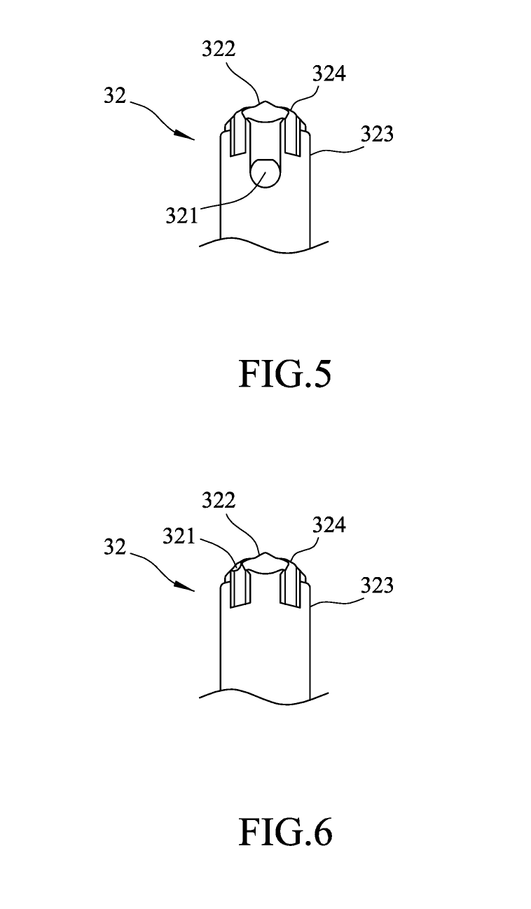

The drill unit 3 includes a bit shaft 31, a bit tip 32 and an externally threaded portion 33. The bit shaft 31 has a tubular shaft wall 310 which is elongated in the lengthwise direction to terminate at proximate and distal shaft ends 311, 312, and which has a shaft inner wall surface that defines a longitudinal passage 300 extending in the lengthwise direction and through the proximate shaft end 311 to form an end opening 301. The bit tip 32 is integrally connected to the distal shaft end 312, and has at least one first penetrating hole 321 in communication with the longitudinal passage 300 for dust access to the longitudinal passage 300. The externally threaded portion 33 is integrally formed on the proximate shaft end 311. Referring to FIG. 5, the bit tip 32 has a tip end edge 322 disposed opposite to the distal shaft end 312, a tip surrounding wall 323 integrally extending from a periphery of the tip end edge 322 to the distal shaft end 312 and surrounding along an axis in the lengthwise direction, and at least one cutting edge 324 extending from the end edge 322 to the tip surrounding wall 323. The first penetrating hole 321 is formed in the tip surrounding wall 323.

The driven shank 4 includes a shank body 41, a driven portion 44 and an internally threaded portion 42. The shank body 41 has a tubular shank wall 410 which is elongated in the lengthwise direction to terminate at proximate and distal shank ends 413, 414 such that the tubular shank wall 410 is disposed to penetrate through the communicating chamber 500 of the socket 5 from the bit end 501 to project the proximate shank end 413 from the bit end 502, and which has a shank inner wall surface 411 that defines a communicating passage 400 extending in the lengthwise direction and through the proximate shank end 413 to form an end opening 401, and at least one second penetrating hole 43 which is configured in communication with the communicating passage 400 and which is adapted to be disposed in the communicating chamber 500 to be in communication with the suction device end 503 of the socket 5. The driven portion 44 is integrally connected to the distal shank end 414, and has a plurality of retaining grooves 441 for retaining a driving device (not shown) so as to be rotated relative to the socket 500. The internally threaded portion 42 is integrally formed on the proximate shank end 413 and extends from the end opening 401 to be threadedly engaged with the externally threaded portion 33 so as to communicate the longitudinal passage 300 with the communicating passage 400. Thus, the first penetrating hole 321, the longitudinal passage 300, the communicating passage 400 and the second penetrating hole 43 cooperatively define an internal dust passageway.

By the suction of the vacuum suction device 6, drilling dust during a hole-drilling operation is sucked from the drilled hole into the suction device 6 through the internal dust passageway without the need of a further dust removal work.

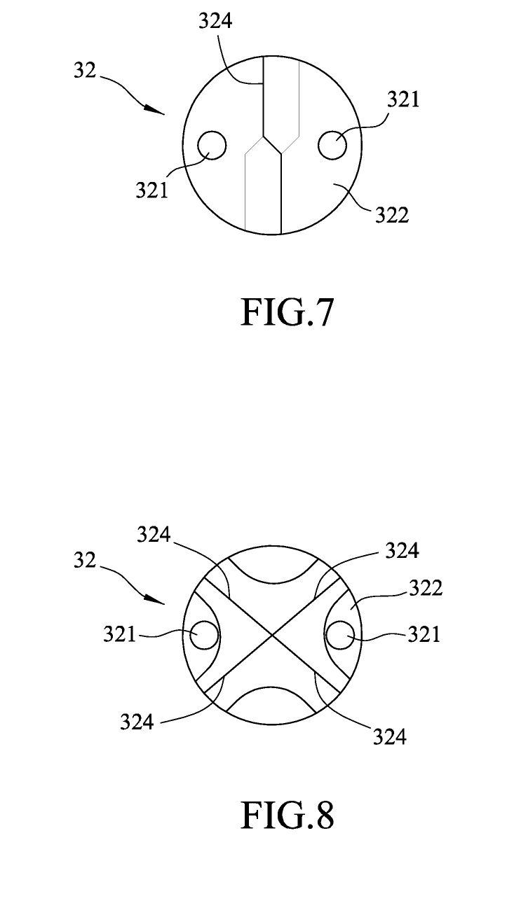

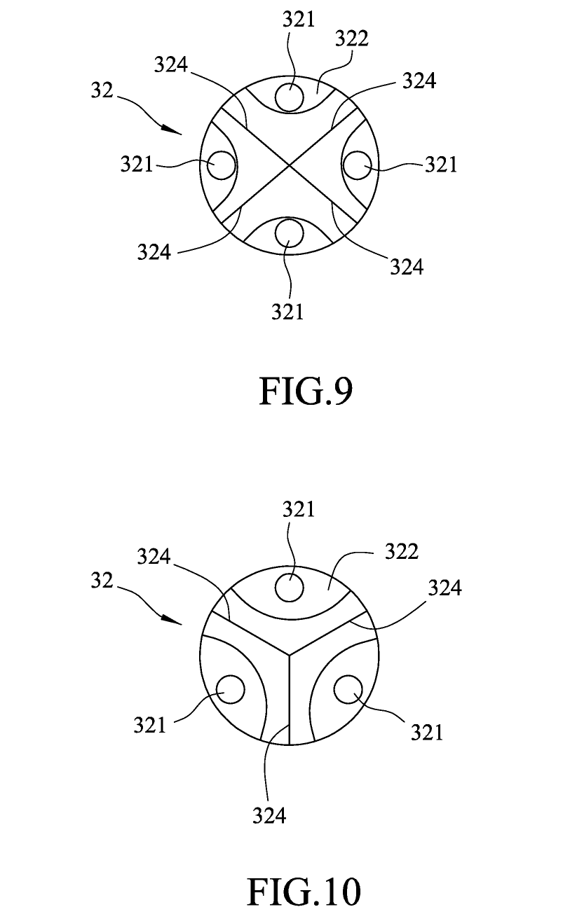

With respect to the bit tip 32, alternatively, referring to FIG. 6, the at least one first penetrating hole 321 is formed in the end edge 322 and is spaced apart from the cutting edge 324 so as to be closer to the drill hole for facilitating dust removal. Further, the first penetrating hole 321 is disposed depending on the number of the cutting edges 324. For example, referring to FIG. 7, in the case that one cutting edge 324 is present, two of the first penetrating holes 321 are formed at two sides of the cutting edge 324, respectively. Referring to FIGS. 8 and 9, when four cutting edges 324 are present, two or four first penetrating holes 321 are each disposed between two adjacent ones of the cutting edges 324. Referring to FIG. 10, in the case that three cutting edges 324 are present, three first penetrating holes 321 are formed in the end edge 322 and each disposed between two adjacent ones of the cutting edges 324.

Referring again to FIGS. 3 and 4, the drill unit 3 can be readily removed from the driven shank 4 by releasing the externally threaded portion 33 from the internally threaded portion 42 which projects outwardly of the socket 5 when the drill unit 3 is broken. The replacement of the drill unit 3 is easy to conduct without the need to detach the driven shank 4 from the socket 5, which results in low operation and material costs.

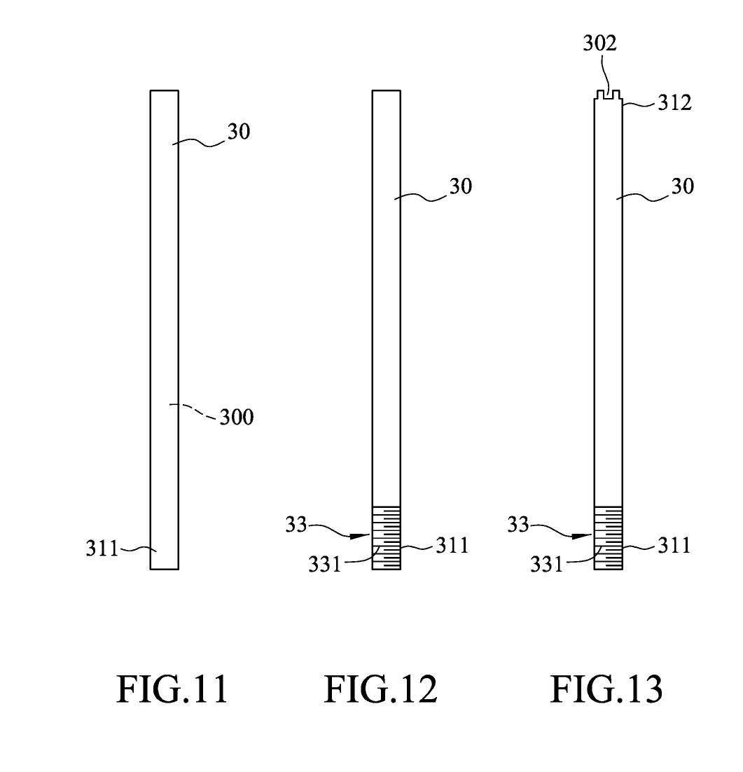

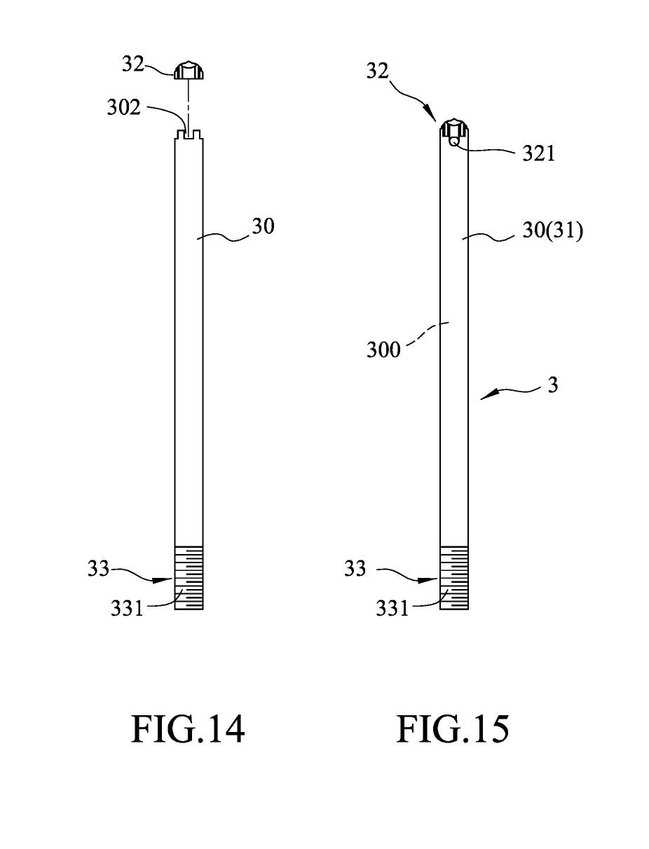

Accordingly, the drill unit 3 and the driven shank 4 may be produced separately. Referring to FIGS. 11 to 15, an embodiment of a method for producing a drill unit 3 includes the steps of: providing a tubular shaft 30 which has a longitudinal passage 300 therein opened at a proximate shaft end 311, forming external threads 331 on the proximate shaft end 311 of the tubular shaft 30 to form an externally threaded portion 33, forming at least one slot 302 in a distal shaft end 312 of the tubular shaft 30 opposite to the proximate shaft end 311, welding a bit tip 32 to the slot 302, and drilling into the bit tip 32 at least one penetrating hole 321 in communication with the longitudinal passage 300.

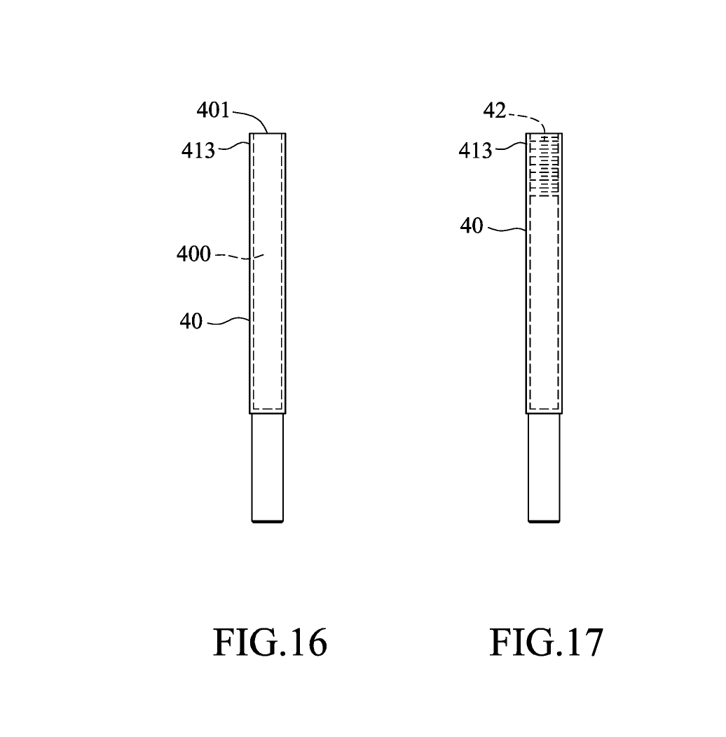

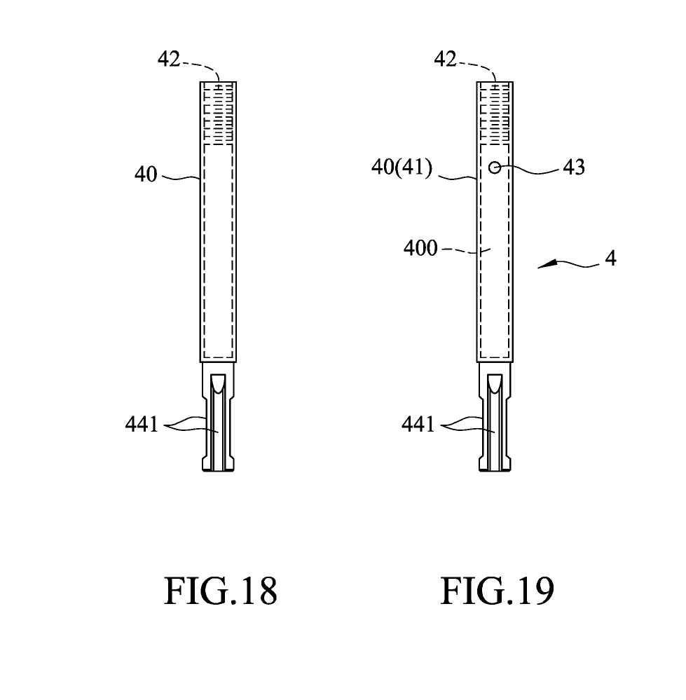

Referring to FIGS. 16 to 19, an embodiment of a method for producing a driven shank 4 includes the steps of: providing a tubular shank 40 which has a communication passage 400 therein opened at a proximate shank end 413, forming an internally threaded portion 42 on the proximate shank end 413, pressing an opposite end of the tubular shank 40 to form a plurality of retaining grooves 441 therein, and drilling into the tubular shank 40 between the internally threaded portion 42 and the retaining grooves 441 at least one penetrating hole 43 in communication with the communication passage 400.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A dust vacuuming drill device adapted to be connected with a vacuum suction device by a socket, the socket defining a communicating chamber that has two bit ends opposite to each other in a lengthwise direction, and a suction device end disposed transverse to the lengthwise direction, comprising:
a drill unit including
a bit shaft having a tubular shaft wall which is elongated in the lengthwise direction to terminate at proximate and distal shaft ends, and which has a shaft inner wall surface that defines a longitudinal passage extending in the lengthwise direction and through said proximate shaft end,
a bit tip integrally connected to said distal shaft end and having at least one first penetrating hole in communication with said longitudinal passage for dust access to said longitudinal passage, and
an externally threaded portion disposed on said proximate shaft end; and
a driven shank including
a shank body having a tubular shank wall which is elongated in the lengthwise direction to terminate at proximate and distal shank ends such that said tubular shank wall is disposed to penetrate through the communicating chamber of the socket from one of the bit ends to project said proximate shank end from the other one of the bit ends, and which has a shank inner wall surface that defines a communicating passage extending in the lengthwise direction and through said proximate shank end, and at least one second penetrating hole which is configured in communication with said communicating passage and which is adapted to be disposed in the communicating chamber to be in communication with the suction device end of the socket,
a driven portion integrally connected to said distal shank end for coupling with a driving device, and
an internally threaded portion disposed on said proximate shank end and configured to be threadedly engaged with said externally threaded portion to communicate said longitudinal passage with said communicating passage such that said first penetrating hole, said longitudinal passage, said communicating passage and said second penetrating hole cooperatively define an internal dust passageway.

2. The dust vacuuming drill device of claim 1, wherein said bit tip has a tip end edge disposed opposite to said distal shaft end, a tip surrounding wall integrally extending from a periphery of said tip end edge to said distal shaft end and surrounding along an axis in the lengthwise direction, and at least one cutting edge extending from said end edge to said tip surrounding wall, said at least one first penetrating hole being formed in said tip surrounding wall.

3. The dust vacuuming drill device of claim 1, wherein said bit tip has a tip end edge disposed opposite to said distal shaft end, a tip surrounding wall integrally extending from a periphery of said tip end edge to said distal shaft end and surrounding along an axis in the lengthwise direction, and a cutting edge extending from said end edge to said tip surrounding wall, said at least one first penetrating hole being formed in said end edge and spaced apart from said cutting edge.

4. The dust vacuuming drill device of claim 1, wherein said driven portion of said driven shank has a plurality of retaining grooves for retaining the driving device.

5. A method for producing a drill unit of a dust vacuuming drill device, comprising:
providing a tubular shaft which has a longitudinal passage therein opened at a proximate shaft end;
forming external threads on said proximate shaft end of said tubular shaft;
forming at least one slot in a distal shaft end of said tubular shaft opposite to said proximate shaft end;
welding a bit tip to said slot; and
drilling into said bit tip at least one penetrating hole in communication with said longitudinal passage.

6. A method for producing a driven shank of a dust vacuuming drill device, comprising:
providing a tubular shank which has a communication passage therein opened at a proximate shank end;
forming an internally threaded portion on said proximate shank end;
pressing an opposite end of said tubular shank to form a plurality of retaining grooves therein; and
drilling into said tubular shank between said internally threaded portion and said retaining grooves at least one penetrating hole in communication with said communication passage.
